(19) United States
(12) Patent Application Publication
(10) Pub. No.: US 2025/0125387 A1
(43) Pub. Date: Apr. 17, 2025

(54) FILTER APPARATUS FOR ELECTROCHEMICAL DEVICE

(71) Applicants: HYUNDAI MOTOR COMPANY, SEOUL (KR); KIA CORPORATION, SEOUL (KR)

(72) Inventors: Won Seok Yang, Yongin-si (KR); Kwi Seong Jeong, Yongin-si (KR); Hyo Kyung Han, Seoul (KR)

(21) Appl. No.: 18/440,632

(22) Filed: Feb. 13, 2024

(30) Foreign Application Priority Data
Oct. 17, 2023 (KR) 10-2023-0138861

(51) Int. Cl. H01M 8/04223; G01F 15/00; G01F 15/12; G01F 15/18

(52) U.S. Cl. CPC H01M 8/04231; G01F 15/005; G01F 15/125; G01F 15/185

(57) ABSTRACT

A filter apparatus for an electrochemical device that improves durability and stability includes a supply line configured to supply a target fluid to an electrochemical device, a first filter part provided in the supply line, a second filter part positioned at a downstream side of the first filter part, a first bypass line having a first end positioned at an upstream side of the first filter part, and a second end positioned between the first filter part and the second filter part, a second bypass line having a first end positioned at a downstream side of the second filter part, and a second end positioned at the upstream side of the first filter part, and a third bypass line having a first end positioned between the first filter part and the second filter part, and a second end positioned at the downstream side of the second filter part.

### CROSS REFERENCE TO RELATED APPLICATIONS

This application claims priority to and the benefit of Korean Patent Application No. 10-2023-0138861 filed in the Korean Intellectual Property Office on Oct. 17, 2023, the entire contents of which are incorporated herein by reference.

### TECHNICAL FIELD

The present disclosure relates to a filter apparatus for an electrochemical device, and more particularly, to a filter apparatus for an electrochemical device, which is capable of ensuring performance of the electrochemical device and improving durability and stability of the electrochemical device.

### BACKGROUND

There is a consistently increasing need for research and development on alternative energy to cope with global warming and depletion of fossil fuel. Hydrogen energy is attracting attention as a practical solution for solving environmental and energy issues.

In particular, because hydrogen has high energy density and properties suitable for application on a grid-scale, hydrogen is in the limelight as a future energy carrier.

A water electrolysis stack, which is one of electrochemical apparatuses, refers to a device that produces hydrogen and oxygen by electrochemically decomposing water. The water electrolysis stack may be configured by stacking several tens or several hundreds of water electrolysis cells (unit cells) in series.

Meanwhile, when a target fluid (reactant) (e.g., water) to be supplied to the electrochemical device (e.g., the water electrolysis stack) contains ions and foreign substances (impurities), the performance, durability, and reliability of the electrochemical device are degraded. Therefore, it is necessary to remove ions and foreign substances contained in the target fluid as much as possible.

### SUMMARY

The present disclosure has been made in an effort to provide a filter apparatus for an electrochemical device, which is capable of ensuring performance of the electrochemical device and improving durability and stability of the electrochemical device.

In particular, the present disclosure has been made in an effort to unify replacement cycles (lifespans) of filter parts and prolong the replacement cycle (lifespan) of the filter part.

The present disclosure has also been made in an effort to provide case of maintenance and repair and reduce maintenance and repair costs.

The present disclosure has also been made in an effort to change characteristics in supplying a target fluid depending on an operating condition of the electrochemical device and effectively cope with a change in load of the electrochemical device.

The objects to be achieved by the embodiments are not limited to the above-mentioned objects, but also include objects or effects that may be understood from the solutions or embodiments described below.

In order to achieve the above-mentioned objects, an exemplary embodiment of the present disclosure provides a filter apparatus for an electrochemical device, the filter apparatus including a supply line configured to supply a target fluid to an electrochemical device, a first filter part provided in the supply line, a second filter part positioned at a downstream side of the first filter part and provided in the supply line, a first bypass line having one end positioned at an upstream side of the first filter part and connected to the supply line, and the other end positioned between the first filter part and the second filter part and connected to the supply line, a second bypass line having one end positioned at a downstream side of the second filter part and connected to the supply line, and the other end positioned at the upstream side of the first filter part and connected to the supply line, and a third bypass line having one end positioned between the first filter part and the second filter part and connected to the supply line, and the other end positioned at the downstream side of the second filter part and connected to the supply line.

The filter apparatus for an electrochemical device according to the exemplary embodiment of the present disclosure may include a first three-way valve positioned at the upstream side of the first filter part, provided in the supply line, and connected to one end of the first bypass line, a second three-way valve positioned between the first filter part and the second filter part, provided in the supply line, and connected to one end of the second bypass line, and a third three-way valve positioned at the downstream side of the second filter part, provided in the supply line, and connected to one end of the second bypass line.

The filter apparatus for an electrochemical device according to the exemplary embodiment of the present disclosure may include: a third filter part positioned at the downstream side of the second filter part and provided in the supply line.

The filter apparatus for an electrochemical device according to the exemplary embodiment of the present disclosure may include a fourth bypass line having one end connected to the first bypass line, and the other end positioned between the second filter part and the third filter part and connected to the supply line, and a fifth bypass line having one end positioned between the second filter part and the third filter part and connected to the supply line, and the other end connected to the third bypass line, in which one end of the second bypass line is positioned at a downstream side of the third filter part and connected to the supply line.

The filter apparatus for an electrochemical device according to the exemplary embodiment of the present disclosure may include a fourth three-way valve positioned between the second filter part and the second three-way valve, provided in the supply line, and connected to the other end of the first bypass line, a fifth three-way valve positioned between the second filter part and the third filter part, provided in the supply line, and connected to one end of the fifth bypass line, and a sixth three-way valve provided in the first bypass line and connected to one end of the fourth bypass line.

The filter apparatus for an electrochemical device according to the exemplary embodiment of the present disclosure may include a first ion sensor positioned at the upstream side of the first filter part, provided in the supply line, and configured to sense ionic conductance of the target fluid, a second ion sensor positioned between the first filter part and the second filter part, provided in the supply line, and configured to sense ionic conductance of the target fluid, a third ion sensor positioned between the second filter part and the third filter part, provided in the supply line, and configured to sense ionic conductance of the target fluid, and a fourth ion sensor positioned at the downstream side of the third filter part, provided in the supply line, and configured to sense ionic conductance of the target fluid.

According to the exemplary embodiment of the present disclosure, the order in which the target fluid passes through the first filter part, the second filter part, and the third filter part may be defined on the basis of sensing results of the first ion sensor, the second ion sensor, the third ion sensor, and the fourth ion sensor.

According to the exemplary embodiment of the present disclosure, the target fluid may be defined to move along any one of a first serial path sequentially passing through the first filter part, the second filter part, and the third filter part, a second serial path sequentially passing through the second filter part, the third filter part, and the first filter part, and a third serial path sequentially passing through the third filter part, the first filter part, and the second filter part.

According to the exemplary embodiment of the present disclosure, the target fluid may be defined to move along a non-transmission path, which does not pass through at least any one of the first filter part, the second filter part, and the third filter part, on the basis of sensing results of the first ion sensor, the second ion sensor, the third ion sensor, and the fourth ion sensor.

The filter apparatus for an electrochemical device according to the exemplary embodiment of the present disclosure may include a first flowmeter positioned at the upstream side of the first filter part, provided in the supply line, and configured to measure a mass flow rate of the target fluid, and a second flowmeter positioned at the downstream side of the third filter part, provided in the supply line, and configured to measure a mass flow rate of the target fluid.

According to the exemplary embodiment of the present disclosure, the target fluid may be defined to move along a parallel path, which simultaneously passes through at least two or more of the first filter part, the second filter part, and the third filter part, on the basis of sensing results of the first flowmeter and the second flowmeter.

The filter apparatus for an electrochemical device according to the exemplary embodiment of the present disclosure may include: a seventh three-way valve provided in the third bypass line and connected to the other end of the fifth bypass line.

In the filter apparatus for an electrochemical device according to the exemplary embodiment of the present disclosure, the second filter part may include a filter module selectively separable from the supply line.

The filter apparatus for an electrochemical device according to the exemplary embodiment of the present disclosure may include a first check valve provided in the second bypass line and configured to restrict a reverse flow of the target fluid, a second check valve provided in the third bypass line and configured to restrict a reverse flow of the target fluid; and a third check valve provided in the fourth bypass line and configured to restrict a reverse flow of the target fluid.

According to the embodiment of the present disclosure described above, it is possible to obtain an advantageous effect of ensuring the performance of the electrochemical device and improving the durability and stability.

In particular, according to the embodiment of the present disclosure, it is possible to obtain an advantageous effect of unifying the replacement cycles (lifespans) of the filter parts and prolonging the replacement cycle (lifespan) of the filter part.

In addition, according to the embodiment of the present disclosure, it is possible to obtain an advantageous effect of facilitating the maintenance and repair and reducing the maintenance and repair costs.

In addition, according to the embodiment of the present disclosure, it is possible to obtain an advantageous effect of changing characteristics in supplying the target fluid in accordance with the operating condition of the electrochemical device and an advantageous effect of effectively coping with a change in load of the electrochemical device.

### BRIEF DESCRIPTION OF THE FIGURES

FIG. 1 is a view for explaining a filter apparatus for an electrochemical device according to an embodiment of the present disclosure.

FIG. 2 is a view for explaining a first serial path of the filter apparatus for an electrochemical device according to the embodiment of the present disclosure.

FIG. 3 is a view for explaining a second serial path of the filter apparatus for an electrochemical device according to the embodiment of the present disclosure.

FIG. 4 is a view for explaining a third serial path of the filter apparatus for an electrochemical device according to the embodiment of the present disclosure.

FIG. 5 is a view for explaining a parallel path of the filter apparatus for an electrochemical device according to the embodiment of the present disclosure.

FIGS. 6, 7, and 8 are views for explaining a non-transmission path of the filter apparatus for an electrochemical device according to the embodiment of the present disclosure.

FIGS. 9 and 10 are views for explaining a filter module of the filter apparatus for an electrochemical device according to the embodiment of the present disclosure.

FIG. 11 is a view for explaining a seventh three-way valve of the filter apparatus for an electrochemical device according to the embodiment of the present disclosure.

### DETAILED DESCRIPTION

Hereinafter, exemplary embodiments of the present disclosure will be described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

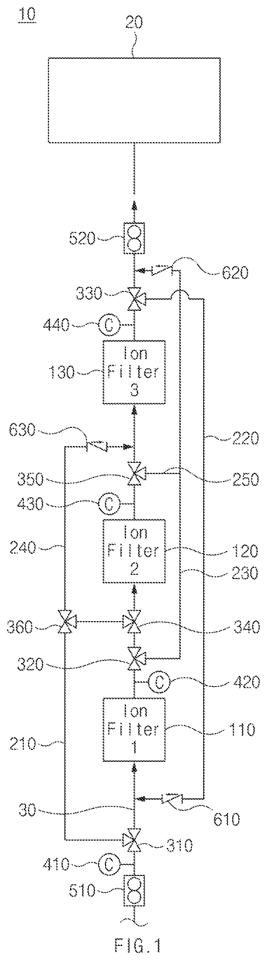

With reference to FIGS. 1 to 11, a filter apparatus 10 for an electrochemical device according to an embodiment of the present disclosure includes a supply line 30 configured to supply a target fluid to an electrochemical device 20, a first filter part 110 provided in the supply line 30, a second filter part 120 provided in the supply line 30 and positioned at a downstream side of the first filter part 110, a first bypass line 210 having one end positioned at an upstream side of the first filter part 110 and connected to the supply line 30 and the other end positioned between the first filter part 110 and the second filter part 120 and connected to the supply line 30, a second bypass line 220 having one end positioned at a downstream side of the second filter part 120 and connected to the supply line 30 and the other end positioned at an upstream side of the first filter part 110 and connected to the supply line 30, and a third bypass line 230 having one end positioned between the first filter part 110 and the second filter part 120 and connected to the supply line 30 and the other end positioned at a downstream side of the second filter part 120 and connected to the supply line 30.

For reference, in the embodiment of the present disclosure, the electrochemical device 20 is defined as including both a water electrolysis stack configured to produce hydrogen and oxygen by decomposing water by means of an electrochemical reaction, and a fuel cell stack configured to generate electrical energy by means of a chemical reaction of fuel (e.g., hydrogen).

Hereinafter, an example will be described in which the filter apparatus 10 for an electrochemical device according to the embodiment of the present disclosure is configured to filter out ions and foreign substances (impurities) contained in a target fluid (reactant) (e.g., water) to be supplied to the water electrolysis stack.

The water electrolysis stack (electrochemical device) may be provided by stacking a plurality of unit cells in a reference stacking direction.

More specifically, the unit cell may include a reaction layer (not illustrated) and the separators (not illustrated) stacked on one surface and the other surface of the reaction layer. The water electrolysis stack may be configured by stacking the plurality of unit cells in the reference stacking direction and assembling endplates (not illustrated) to the two opposite ends of the plurality of unit cells.

The reaction layer may have various structures capable of generating the electrochemical reaction of the target fluid (e.g., water). The present disclosure is not restricted or limited by the type and structure of the reaction layer.

For example, the reaction layer may include a membrane electrode assembly (MEA) (not illustrated), a first porous transport layer (not illustrated) in close contact with one surface of the membrane electrode assembly, and a second porous transport layer (not illustrated) in close contact with the other surface of the membrane electrode assembly.

The membrane electrode assembly may be variously changed in structure and material in accordance with required conditions and design specifications. The present disclosure is not restricted or limited by the structure and material of the membrane electrode assembly.

For example, the membrane electrode assembly may be configured by attaching catalyst electrode layers (e.g., an anode layer and a cathode layer), in which electrochemical reactions are generated, to two opposite surfaces of an electrolyte membrane (e.g., a perfluorinated sulfonic acid ionomer-based electrolyte membrane).

The first and second porous transport layers may uniformly distribute the target fluid and each have a porous structure having pores with predetermined sizes.

For reference, the water (target fluid) supplied to the anode layer, which is an oxidation electrode for the water electrolysis, is separated into hydrogen ions (protons), electrons, and oxygen. Then, the hydrogen ions move to the cathode layer, which is a reduction electrode, through the electrolyte membrane, and the electrons move to a cathode through an external circuit. In addition, the oxygen may be discharged through an anode outlet, and the hydrogen ions and the electrons may be converted into hydrogen at the cathode.

The supply line 30 is configured to supply the target fluid from a target fluid supply part (not illustrated) to the electrochemical device 20 (e.g., water electrolysis stack).

The supply line 30 may have various structures in accordance with required conditions and design specifications. The present disclosure is not restricted or limited by the structure and shape of the supply line 30.

For example, the supply line 30 may be defined in an approximately straight shape. According to another embodiment of the present disclosure, the supply line may have an “L” shape, a curved shape, or other shapes.

The first filter part 110 is provided in the supply line 30 and configured to filter out ions and foreign substances (impurities) contained in the target fluid (reactant) (e.g., water) to be supplied to the water electrolysis stack along the supply line 30.

Various ion filters capable of filtering out ions and foreign substances (impurities) contained in the target fluid may be used as the first filter part 110. The present disclosure is not restricted or limited by the type and properties of the ion filter. For example, a fluorine resin-based ion exchange membrane, a porous ceramic separator, ion exchange resin, silica gel, or the like may be used as the first filter part 110.

The second filter part 120 is provided in the supply line 30 and configured to filter out ions and foreign substances (impurities) contained in the target fluid (reactant) (e.g., water) to be supplied to the water electrolysis stack along the supply line 30. The second filter part 120 is provided in the supply line 30 and positioned at the downstream side of the first filter part 110 (an upper side of the first filter part based on FIG. 1).

Various ion filters capable of filtering out ions and foreign substances (impurities) contained in the target fluid may be used as the second filter part 120. The present disclosure is not restricted or limited by the type and properties of the ion filter. For example, a fluorine resin-based ion exchange membrane, a porous ceramic separator, ion exchange resin, silica gel, or the like may be used as the second filter part 120.

According to the exemplary embodiment of the present disclosure, the filter apparatus 10 for an electrochemical device may include a third filter part 130 provided in the supply line 30 and positioned at the downstream side of the second filter part 120.

The third filter part 130 is provided in the supply line 30 and configured to filter out ions and foreign substances (impurities) contained in the target fluid (reactant) (e.g., water) to be supplied to the water electrolysis stack along the supply line 30. The third filter part 130 is provided in the supply line 30 and positioned at the downstream side of the second filter part 120 (an upper side of the second filter part based on FIG. 1).

Various ion filters capable of filtering out ions and foreign substances (impurities) contained in the target fluid may be used as the third filter part 130. The present disclosure is not restricted or limited by the type and properties of the ion filter. For example, a fluorine resin-based ion exchange membrane, a porous ceramic separator, ion exchange resin, silica gel, or the like may be used as the third filter part 130.

For reference, in the embodiment of the present disclosure illustrated and described above, the example has been described in which the filter apparatus 10 for an electrochemical device includes the three filter parts (the first filter part, the second filter part, and the third filter part). However, according to another embodiment of the present disclosure, the filter apparatus for an electrochemical device may include four or more filter parts.

The first bypass line 210 is configured to allow a part (or the entirety) of the target fluid supplied to the supply line 30 to selectively flow to the second filter part 120 (or the third filter part) without passing through the first filter part 110.

More specifically, one end of the first bypass line 210 is positioned at the upstream side of the first filter part 110 (a lower side of the first filter part based on FIG. 1) and connected to the supply line 30, and the other end of the first bypass line 210 is positioned between the first filter part 110 and the second filter part 120 (e.g., between the second filter part and a second three-way valve) and connected to the supply line 30.

The first bypass line 210 may have various structures in accordance with required conditions and design specifications. The present disclosure is not restricted or limited by the structure and shape of the first bypass line 210. For example, the first bypass line 210 may have an approximately “U” shape.

The second bypass line 220 is configured to allow the target fluid, which has passed through the second filter part 120, to selectively flow to the upstream side of the first filter part 110.

More specifically, one end of the second bypass line 220 is positioned at the downstream side of the second filter part 120 (e.g., the downstream side of the third filter part) and connected to the supply line 30, and the other end of the second bypass line 220 is positioned at the upstream side of the first filter part 110 (e.g., positioned between the first filter part and a first three-way valve) and connected to the supply line 30.

The second bypass line 220 may have various structures in accordance with required conditions and design specifications. The present disclosure is not restricted or limited by the structure and shape of the second bypass line 220. For example, the second bypass line 220 may have an approximately “U” shape.

The third bypass line 230 is configured to allow the target fluid, which has passed through the first filter part 110, to selectively flow to the downstream side of the third filter part 130 without passing through the second filter part 120 and the third filter part 130.

More specifically, one end of the third bypass line 230 is positioned between the first filter part 110 and the second filter part 120 (e.g., between the first filter part and a fourth three-way valve) and connected to the supply line 30, and the other end of the third bypass line 230 is positioned at the downstream side of the second filter part 120 and connected to the supply line 30.

The third bypass line 230 may have various structures in accordance with required conditions and design specifications. The present disclosure is not restricted or limited by the structure and shape of the third bypass line 230. For example, the third bypass line 230 may have an approximately “U” shape.

According to the exemplary embodiment of the present disclosure, the filter apparatus 10 for an electrochemical device includes a fourth bypass line 240 having one end connected to the first bypass line 210 and the other end positioned between the second filter part 120 and the third filter part 130 and connected to the supply line 30, and a fifth bypass line 250 having one end positioned between the second filter part 120 and the third filter part 130 and connected to the supply line 30 and the other end connected to the third bypass line 230.

The fourth bypass line 240 is configured to allow the target fluid, which flows along the first bypass line 210, to selectively flow to the third filter part 130 without passing through the second filter part 120.

More specifically, one end of the fourth bypass line 240 is connected to the first bypass line 210 (e.g., positioned between the first three-way valve and the fourth three-way valve and connected to the first bypass line 210), and the other end of the fourth bypass line 240 is positioned between the second filter part 120 and the third filter part 130 (e.g., between the third filter part and a fifth three-way valve) and connected to the supply line 30.

The fourth bypass line 240 may have various structures in accordance with required conditions and design specifications. The present disclosure is not restricted or limited by the structure and shape of the fourth bypass line 240. For example, the fourth bypass line 240 may have an approximately “L” shape.

The fifth bypass line 250 is configured to allow the target fluid, which has passed through the second filter part 120, to selectively flow to the downstream side of the third filter part 130 without passing through the third filter part 130.

More specifically, one end of the fifth bypass line 250 is positioned between the second filter part 120 and the third filter part 130 (e.g., between the other end of the fourth bypass line and the second filter part) and connected to the supply line 30, and the other end of the fifth bypass line 250 is connected to the third bypass line 230.

The fifth bypass line 250 may have various structures in accordance with required conditions and design specifications. The present disclosure is not restricted or limited by the structure and shape of the fifth bypass line 250. For example, the third bypass line 230 may have an approximately straight shape.

The process of switching the routes for the target fluid from the supply line 30 to the first to fifth bypass lines 210, 220, 230, 240, and 250 may be implemented in various ways in accordance with required conditions and design specifications. The present disclosure is not restricted or limited by the structure and method for switching the routes for the target fluid.

According to the exemplary embodiment of the present disclosure, the filter apparatus 10 for an electrochemical device may include a first three-way valve 310 positioned at the upstream side of the first filter part 110, provided in the supply line 30, and connected to one end of the first bypass line 210, a second three-way valve 320 positioned between the first filter part 110 and the second filter part 120, provided in the supply line 30, and connected to one end of the second bypass line 220, a third three-way valve 330 positioned at the downstream side of the second filter part 120, provided in the supply line 30, and connected to one end of the second bypass line 220, a fourth three-way valve 340 positioned between the second filter part 120 and the second three-way valve 320, provided in the supply line 30, and connected to the other end of the first bypass line 210, a fifth three-way valve 350 positioned between the second filter part 120 and the third filter part 130, provided in the supply line 30, and connected to the one end of the fifth bypass line 250, and a sixth three-way valve 360 provided in the first bypass line 210 and connected to one end of the fourth bypass line 240. The movement routes for the target fluid may be selectively switched by means of the first to sixth three-way valves 310, 320, 330, 340, 350, and 360.

The first three-way valve 310 is positioned at the upstream side of the first filter part 110, provided in the supply line 30, and connected to one end of the first bypass line 210.

Various three-way valves capable of allowing a part (or the entirety) of the target fluid supplied to the supply line 30 to selectively flow to the second filter part 120 (or the third filter part) may be used as the first three-way valve 310. The present disclosure is not restricted or limited by the type and structure of the first three-way valve 310.

For example, the first three-way valve 310 may include a first port (not illustrated) into which the target fluid supplied to the supply line 30 is introduced, a second port configured to guide the target fluid, which has passed through the first port, to the second filter part 120, and a third port (not illustrated) connected to one end of the first bypass line 210 so that the target fluid, which has passed through the first port, is supplied to the first bypass line 210. The movement routes for the target fluid may be selectively switched by opening or closing the first to third ports.

In this case, the operation of opening or closing the first to third ports is defined as including both an operation of completely closing or opening the first to third ports and an operation of adjusting an opening degree (valve opening angle) (e.g., adjusting a degree to which the port is opened).

The second three-way valve 320 is positioned between the first filter part 110 and the second filter part 120, provided in the supply line 30, and connected to one end of the second bypass line 220.

Various three-way valves capable of allowing the target fluid, which has passed through the first filter part 110, to selectively flow to the downstream side of the third filter part 130 may be used as the second three-way valve 320. The present disclosure is not restricted or limited by the type and structure of the second three-way valve 320. For example, the second three-way valve 320 may have a structure identical or similar to the above-mentioned structure of the first three-way valve 310.

The third three-way valve 330 may be positioned at the downstream side of the second filter part 120, provided in the supply line 30, and connected to one end of the second bypass line 220.

Various three-way valves capable of allowing the target fluid, which has passed through the second filter part 120 (the third filter part), to selectively flow to the upstream side of the first filter part 110 may be used as the third three-way valve 330. The present disclosure is not restricted or limited by the type and structure of the third three-way valve 330. For example, the third three-way valve 330 may have a structure identical or similar to the above-mentioned structure of the first three-way valve 310.

The fourth three-way valve 340 is positioned between the second filter part 120 and the second three-way valve 320, provided in the supply line 30, and connected to the other end of the first bypass line 210.

Various three-way valves capable of allowing the target fluid, which flows along the first bypass line 210, to selectively flow to the third filter part 130 may be used as the fourth three-way valve 340. The present disclosure is not restricted or limited by the type and structure of the fourth three-way valve 340. For example, the fourth three-way valve 340 may have a structure identical or similar to the above-mentioned structure of the first three-way valve 310.

The fifth three-way valve 350 is positioned between the second filter part 120 and the third filter part 130, provided in the supply line 30, and connected to one end of the fifth bypass line 250.

Various three-way valves capable of allowing the target fluid, which has passed through the second filter part 120, to selectively flow to the downstream side of the third filter part 130 may be used as the fifth three-way valve 350. The present disclosure is not restricted or limited by the type and structure of the fifth three-way valve 350. For example, the fifth three-way valve 350 may have a structure identical or similar to the above-mentioned structure of the first three-way valve 310.

The sixth three-way valve 360 is provided in the first bypass line 210 and connected to one end of the fourth bypass line 240.

Various three-way valves capable of allowing the target fluid, which flows along the first bypass line 210, to selectively flow to the second filter part 120 or the third filter part 130 may be used as the sixth three-way valve 360. The present disclosure is not restricted or limited by the type and structure of the sixth three-way valve 360. For example, the sixth three-way valve 360 may have a structure identical or similar to the above-mentioned structure of the first three-way valve 310.

The movement routes for the target fluid may be variously changed in accordance with required conditions and a remaining lifespan or the like of the filter part. The present disclosure is not restricted or limited by the movement route for the target fluid.

According to the exemplary embodiment of the present disclosure, the filter apparatus 10 for an electrochemical device may include a first ion sensor 410 positioned at the upstream side of the first filter part 110, provided in the supply line 30, and configured to sense ionic conductance of the target fluid, a second ion sensor 420 positioned between the first filter part 110 and the second filter part 120, provided in the supply line 30, and configured to sense ionic conductance of the target fluid, a third ion sensor 430 positioned between the second filter part 120 and the third filter part 130, provided in the supply line 30, and configured to sense ionic conductance of the target fluid, and a fourth ion sensor 440 positioned at the downstream side of the third filter part 130, provided in the supply line 30, and configured to sense ionic conductance of the target fluid.

Various ion sensors capable of sensing the ionic conductance of the target fluid may be used as the first to fourth ion sensors 410, 420, 430, and 440. The present disclosure is not restricted or limited by the types and structures of the first to fourth ion sensors 410, 420, 430, and 440.

The movement route for the target fluid may be defined on the basis of the sensing results of the first ion sensor 410, the second ion sensor 420, the third ion sensor 430, and the fourth ion sensor 440.

According to the exemplary embodiment of the present disclosure, the order in which the target fluid passes through the first filter part 110, the second filter part 120, and the third filter part 130 may be defined on the basis of the sensing results of the first ion sensor 410, the second ion sensor 420, the third ion sensor 430, and the fourth ion sensor 440.

According to the exemplary embodiment of the present disclosure, on the basis of the sensing results of the first ion sensor 410, the second ion sensor 420, the third ion sensor 430, and the fourth ion sensor 440, the target fluid may be defined to move along any one of a first serial path sequentially passing through the first filter part 110, the second filter part 120, and the third filter part 130 (the first filter part→the second filter part→the third filter part), a second serial path sequentially passing through the second filter part 120, the third filter part 130, and the first filter part 110 (the second filter part→the third filter part→the first filter part), and a third serial path sequentially passing through the third filter part 130, the first filter part 110, and the second filter part 120 (the third filter part→the first filter part→the second filter part).

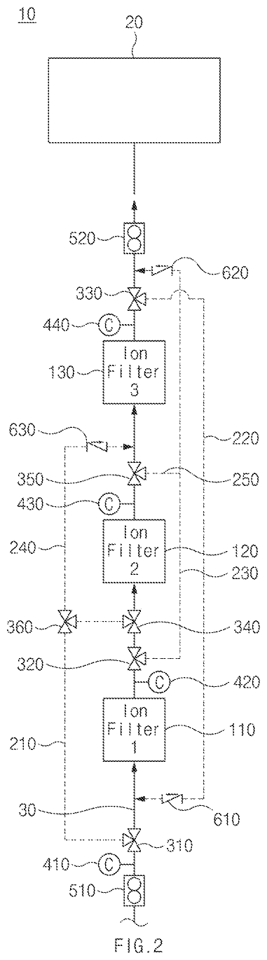

With reference to FIG. 2, the target fluid may be basically defined to move along the first serial path sequentially passing through the first filter part 110, the second filter part 120, and the third filter part 130 (the first filter part→the second filter part→the third filter part).

The first to sixth three-way valves 310, 320, 330, 340, 350, and 360 are controlled while the target fluid moves along the first serial path, such that the target fluid may be prevented from flowing from the supply line 30 to the first to fifth bypass lines 210, 220, 230, 240, and 250.

Meanwhile, in case that the target fluid moves along the first serial path, the first filter part 110, which is disposed at a most upstream side among the first to third filter parts 110, 120, and 130, filters most contaminated water, and the first filter part 110 is used more frequently than the second and third filter parts 120 and 130 disposed at the downstream side, such that the lifespan of the first filter part 110 may be more quickly shortened.

It is possible to determine that the end of the lifespan of the first filter part 110 is reached when a difference between the ionic conductance of the target fluid sensed by the first ion sensor 410 and the ionic conductance of the target fluid sensed by the second ion sensor 420 (a difference between the ionic conductance of the target fluid sensed at the upstream side of the first filter part and the ionic conductance of the target fluid sensed at the downstream side of the first filter part) is within a preset reference range.

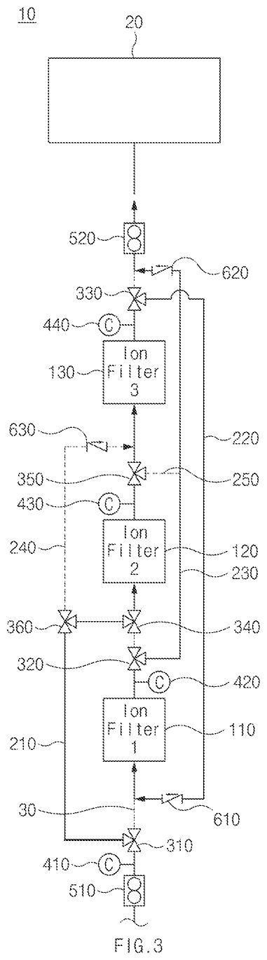

In case that the remaining lifespan of the first filter part 110 is less than a preset reference lifespan, the first to sixth three-way valves 310, 320, 330, 340, 350, and 360 are controlled as illustrated in FIG. 3, such that the target fluid may move along the second serial path sequentially passing through the second filter part 120, the third filter part 130, and the first filter part 110 (the second filter part→the third filter part→the first filter part).

More specifically, the second serial path may be defined as a path sequentially passing through the first bypass line 210→the second filter part 120→the third filter part 130→the second bypass line 220→the first filter part 110→the third bypass line 230.

With the above-mentioned method, it is possible to determine that the end of the lifespan of the second filter part 120 is reached when a difference between the ionic conductance of the target fluid sensed by the first ion sensor 410 and the ionic conductance of the target fluid sensed by the third ion sensor 430 (a difference between the ionic conductance of the target fluid sensed at the upstream side of the second filter part and the ionic conductance of the target fluid sensed at the downstream side of the second filter part) is within the preset reference range.

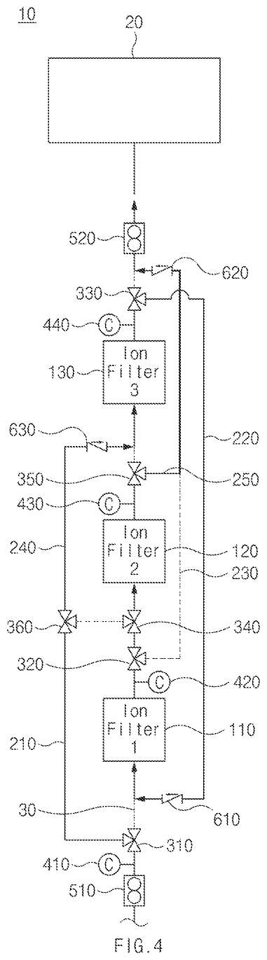

In case that the remaining lifespan of the second filter part 120 is less than the preset reference lifespan, the first to sixth three-way valves 310, 320, 330, 340, 350, and 360 are controlled as illustrated in FIG. 4, such that the target fluid may move along the third serial path sequentially passing through the third filter part 130, the first filter part 110, and the second filter part 120 (the third filter part→the first filter part→the second filter part).

More specifically, the third serial path may be defined as a path sequentially passing through the first bypass line 210→the fourth bypass line→the third filter part 130→the second bypass line 220→the first filter part 110→the second filter part 120→the fifth bypass line 250→the third bypass line 230.

As described above, in the embodiment of the present disclosure, the target fluid sequentially moves along the first serial path, the second serial path, and the second serial path. Therefore, it is possible to obtain an advantageous effect of unifying replacement cycles (lifespans) of the filter parts and prolonging the replacement cycle (lifespan) of the filter part.

For example, in the embodiment of the present disclosure, the ion filter (e.g., the first filter part), which is disposed at the most upstream side and reaches the end of the lifespan first when the target fluid moves along the first serial path for a predetermined time or longer, is disposed at the most downstream side of the movement route for the target fluid (e.g., disposed at the most downstream side among the first to third filter parts. Therefore, it is possible to obtain an advantageous effect of unifying the replacement cycles (lifespans) of the filter parts and prolonging the replacement cycle (lifespan) of the filter part.

Moreover, according to the embodiment of the present disclosure, the first to third filter parts 110, 120, and 130 may be replaced at the same replacement time point. Therefore, it is possible to obtain an advantageous effect of minimizing the stop of the supply of the target fluid and the stop of the operation of the electrochemical device 20, which may be caused by the frequent replacement of the filter part, and reducing costs and time required to replace the filter part.

In the embodiment of the present disclosure illustrated and described above, the example has been described in which the first to third filter parts 110, 120, and 130 are replaced at the same replacement time point. However, according to another embodiment of the present disclosure, in case that the target fluid (e.g., ultra-pure water) requires reliability (low ionic conductance characteristics) because of the operating characteristics of the electrochemical device 20, the ion filter (e.g., the first filter part), which is disposed at the most upstream side and reaches the end of the lifespan first, may be replaced first, and then a new filter may be disposed at the most downstream side of the movement route for the target fluid, such that the target fluid may pass last through the new filter with the best filter performance. Therefore, it is possible to maintain the maximally low ionic conductance of the target fluid to be supplied to the electrochemical device 20.

In the embodiment of the present disclosure illustrated and described above, the example has been described in which the target fluid moves along the serial path (e.g., the first serial path, the second serial path, or the third serial path). However, according to another embodiment of the present disclosure, the target fluid may move along a parallel path that simultaneously passes through a plurality of filter parts.

According to the exemplary embodiment of the present disclosure, the filter apparatus 10 for an electrochemical device may include a first flowmeter 510 positioned at the upstream side of the first filter part 110, provided in the supply line 30, and configured to measure a mass flow rate of the target fluid, and a second flowmeter 520 positioned at the downstream side of the third filter part 130, provided in the supply line 30, and configured to measure the mass flow rate of the target fluid.

According to the exemplary embodiment of the present disclosure, on the basis of the sensing results of the first flowmeter 510 and the second flowmeter 520, the target fluid may be defined to move along the parallel path simultaneously passing through at least two or more of the first filter part 110, the second filter part 120, and the third filter part 130.

This is to solve a problem caused when the target fluid is supplied at a high flow rate in a situation in which the target fluid needs to be supplied at a high flow rate to the electrochemical device 20.

For example, the target fluid is used as a reactant in the water electrolysis stack (the electrochemical device). In case that an operating load of the water electrolysis stack increases, the target fluid needs to be supplied at a high flow rate to the water electrolysis stack.

In addition, in the electrochemical system, the target fluid also serves to cool the electrochemical device 20 (e.g., the water electrolysis stack). Even when the amount of heat generated by the water electrolysis stack (or the fuel cell stack) increases or the ambient temperature increases such that the electrochemical device 20 needs to be further cooled, the target fluid needs to be supplied at a high flow rate to the water electrolysis stack (or the fuel cell stack).

In case that the target fluid moves along the serial path (e.g., the first serial path, the second serial path, or the third serial path) in the above-mentioned situation, the target fluid is supplied at a flow rate higher than a designed capacity of the filter parts. For this reason, a differential pressure may increase, which may cause a leak from the filter part and pipes or damage the filter part. In addition, when the supply flow rate of the target fluid is insufficient because of the leak of the target fluid, there occurs a problem in that the operation of the electrochemical device 20 is stopped, or the operation is inevitably operated in a severe operating condition.

However, according to the embodiment of the present disclosure, the target fluid moves along the parallel path simultaneously passing through the plurality of filter parts in the situation in which the target fluid needs to be supplied at a high flow rate, thereby solving the above-mentioned problems.

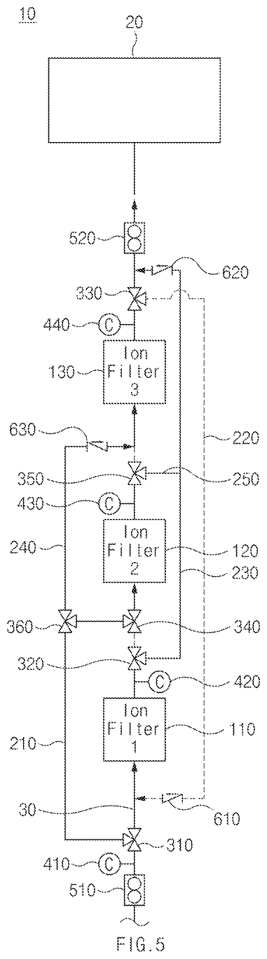

That is, with reference to FIG. 5, when a flow rate of target fluid measured by each of the first and second flowmeters 510 and 520 is higher than a preset reference flow rate, the first to sixth three-way valves 310, 320, 330, 340, 350, and 360 are controlled, such that the target fluid may be defined to move along the parallel path simultaneously passing through the first filter part 110, the second filter part 120, and the third filter part 130.

More specifically, a part of the target fluid supplied to the supply line 30 may be supplied to the electrochemical device 20 along a path sequentially passing through the first filter part 110→the second bypass line 220, another part of the target fluid supplied to the supply line 30 may be supplied to the electrochemical device 20 along a path sequentially passing through the first bypass line 210→the second filter part 120→the fifth bypass line 250→the third bypass line 230, and still another part of the target fluid supplied to the supply line 30 may be supplied to the electrochemical device 20 along a path sequentially passing through the first bypass line 210→fourth bypass line→the third filter part 130.

As described above, according to the embodiment of the present disclosure, the target fluid may move along the parallel path simultaneously passing through the plurality of filter parts, thereby stably supplying the target fluid at a high flow rate and effectively coping with a risk such as an increase in operating load.

In addition, according to the embodiment of the present disclosure, it is possible to determine whether the filter part leaks on the basis of the flow rates of the target fluid measured by the first and second flowmeters 510 and 520 while the target fluid moves along the serial path (e.g., the first serial path, the second serial path, or the third serial path). For example, it is possible to determine that the filter part leaks when the flow rate (outlet flow rate) of the target fluid measured by the second flowmeter 520 is lower than the flow rate (inlet flow rate) of the target fluid measured by the first flowmeter 510.

Moreover, when it is determined that a leak occurs, the movement route for the target fluid is switched from the serial path to the parallel path (the parallel path along which the target fluid simultaneously passes through the plurality of filter parts). Therefore, it is possible to obtain an advantageous effect of minimizing a differential pressure applied to the filter part and minimizing the occurrence of a leak.

In the embodiment of the present disclosure illustrated and described above, the example has been described in which the target fluid passes through all the filter parts along the serial path or the parallel path. However, according to another embodiment of the present disclosure, the target fluid may be configured to pass through only some of the plurality of filter parts.

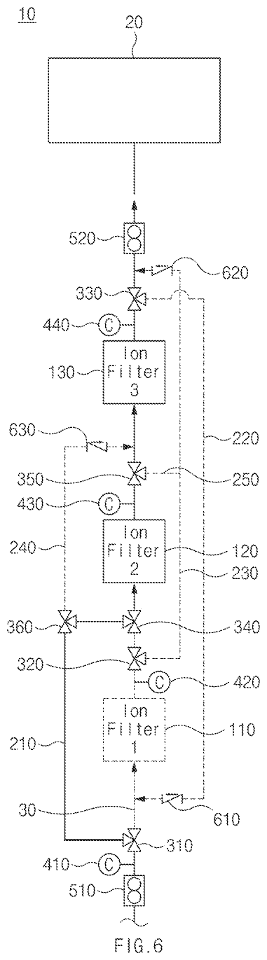

With reference to FIGS. 6 to 8, according to the exemplary embodiment of the present disclosure, on the basis of the sensing results of the first ion sensor 410, the second ion sensor 420, the third ion sensor 430, and the fourth ion sensor 440, the target fluid may be defined to move along a non-transmission path that does not pass through at least any one of the first filter part 110, the second filter part 120, and the third filter part 130.

According to the embodiment of the present disclosure described above, the target fluid moves along the non-transmission path that does not pass through at least any one of the first filter part 110, the second filter part 120, and the third filter part 130. Therefore, even when a particular filter part has a problem, the process of replacing the particular filter part may be performed without cutting off the supply of the target fluid to the electrochemical device 20.

For example, in the event of a problem with the filter part (e.g., any one of the first to third filter parts 110, 120, and 130), such as a leak, the end of the lifespan, and a defect, the defective filter part needs to be replaced. In the embodiment of the present disclosure, the target fluid moves along the non-transmission path that does not pass through the defective filter part, and thus the process of replacing the defective filter part may be performed without cutting off the supply of the target fluid to the electrochemical device 20.

For example, with reference to FIG. 6, it is possible to determine whether the first filter part 110 is defective (e.g., whether a leak occurs or the end of the lifespan is reached) on the basis of the ionic conductance of the target fluid sensed by the first ion sensor 410 and the ionic conductance of the target fluid sensed by the second ion sensor 420 (the ionic conductance of the target fluid sensed at the upstream side of the first filter part and the ionic conductance of the target fluid sensed at the downstream side of the first filter part). When it is determined that the first filter part 110 is defective, the first to sixth three-way valves 310, 320, 330, 340, 350, and 360 may be controlled, such that the first filter part 110 may be replaced with a new filter part while the target fluid moves along the non-transmission path that does not pass through the first filter part 110.

More specifically, the non-transmission path may be defined as a path sequentially passing through the first bypass line 210→the second filter part 120→the third filter part 130, and the target fluid may move along the non-transmission path that does not pass through the first filter part 110. Thereafter, the first to sixth three-way valves 310, 320, 330, 340, 350, and 360 may be controlled so that the target fluid moves again along the route passing through the first filter part 110 after the first filter part 110 is replaced.

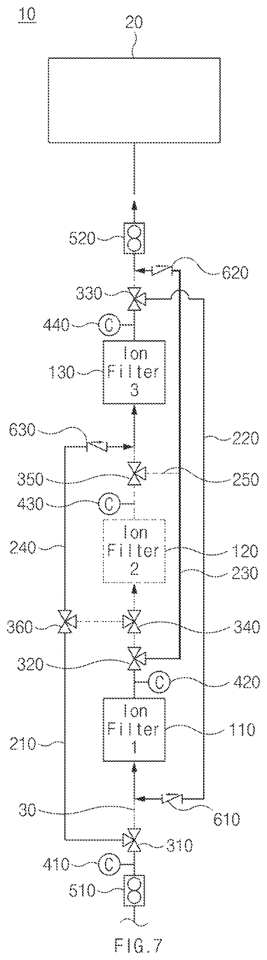

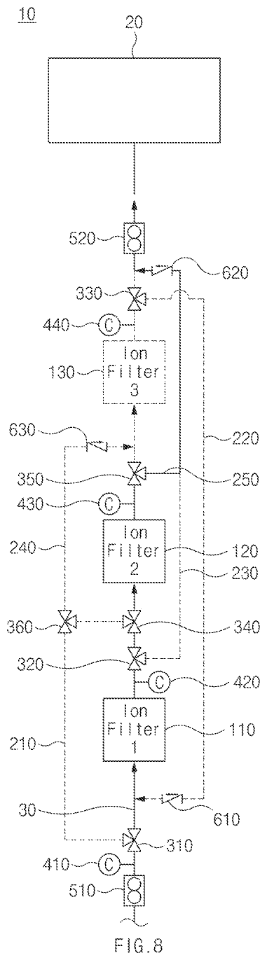

With the above-mentioned method, when it is determined that the second filter part 120 is defective, as illustrated in FIG. 7, the first to sixth three-way valves 310, 320, 330, 340, 350, and 360 may be controlled, such that the second filter part 120 may be replaced with a new filter part while the target fluid moves along the non-transmission path that does not pass through the second filter part 120. In addition, as illustrated in FIG. 8, when it is determined that the third filter part 130 is defective, the first to sixth three-way valves 310, 320, 330, 340, 350, and 360 may be controlled, such that the third filter part 130 may be replaced with a new filter part while the target fluid moves along the non-transmission path that does not pass through the third filter part 130.

As described above, according to the embodiment of the present disclosure, the target fluid selectively moves along the non-transmission path. Therefore, it is possible to perform the process of replacing the particular filter part (defective filter part) without cutting off the supply of the target fluid to the electrochemical device 20 (or without stopping the operation of the electrochemical device). Moreover, the embodiment of the present disclosure may prevent a shutdown caused by the supply of the target fluid, such that it is possible to obtain an advantageous effect of improving durability and stability.

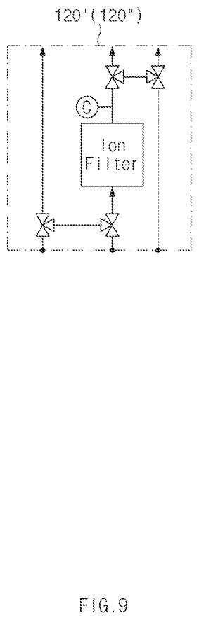

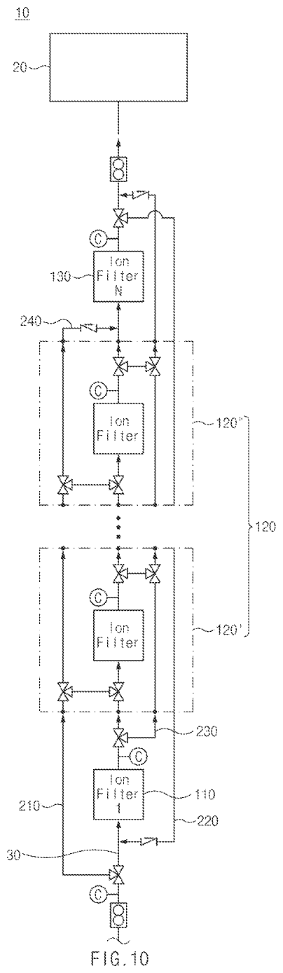

Meanwhile, with reference to FIGS. 9 and 10, according to the exemplary embodiment of the present disclosure, the second filter part 120 may include a filter module 120′ or 120″ selectively separable from the supply line 30.

That is, according to the exemplary embodiment of the present disclosure, the second filter part 120, which is provided between the filter part (e.g., the first filter part), which is provided at the most upstream side of the movement route for the target fluid, and the filter part (e.g., the third filter part), which is provided at the most downstream side, may be configured as the filter module 120′ or 120″ that is selectively detachable.

In the embodiment of the present disclosure, the filter module 120′ or 120″ may be defined as including all a filter member (not illustrated) configured to filter out ions and foreign substances (impurities) contained in the target fluid, a pipe (line) (not illustrated) connected to the filter member, and a valve (not illustrated) provided in the pipe.

The pipe and valve connected to the filter member may be variously changed in structure and number in accordance with required conditions and design specifications. The present disclosure is not restricted or limited by the structures of the pipe and valve connected to the filter member and the number of pipes and valves.

For example, with reference to FIG. 10, the second filter part 120 may include a first filter module 120′ detachably connected to the supply line 30, and a second filter module 120″ detachably connected to the supply line 30 and the first filter module 120′. According to another embodiment of the present disclosure, the second filter part may include a single filter module or include three or more filter modules.

As described above, in the embodiment of the present disclosure, the filter modules 120′ and 120″, which are modularized to have preset dimensions and structures, are used to constitute the second filter part 120. Therefore, it is possible to obtain an advantageous effect of simplifying the structure and the installation process, reducing costs, and facilitating maintenance. Moreover, according to the embodiment of the present disclosure, the processing capacity of the filter apparatus 10 for an electrochemical device may be increased or decreased by selectively increasing or decreasing the number of filter modules 120′ and 120″ without changing an overall structure of the filter apparatus 10 for an electrochemical device.

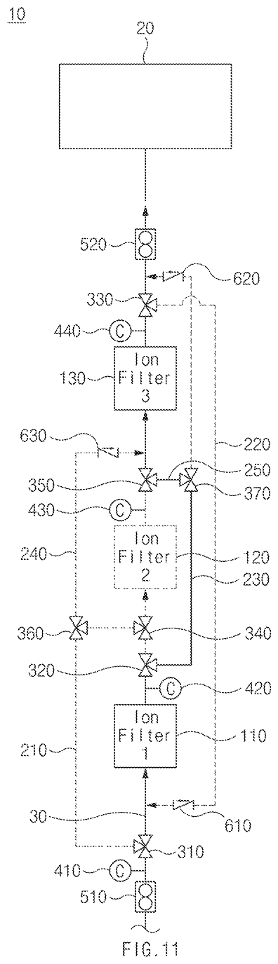

With reference to FIG. 11, according to the exemplary embodiment of the present disclosure, the filter apparatus 10 for an electrochemical device may include a seventh three-way valve 370 provided in the third bypass line 230 and connected to the other end of the fifth bypass line 250.

Various three-way valves capable of allowing the target fluid, which has passed through the first filter part 110, to flow to the third filter part 130 along the third bypass line 230 may be used as the seventh three-way valve 370. The present disclosure is not restricted or limited by the type and structure of the seventh three-way valve 370. For example, the seventh three-way valve 370 may have a structure identical or similar to the above-mentioned structure of the first three-way valve 310.

Because the seventh three-way valve 370 is provided in the embodiment of the present disclosure as described above, the target fluid may be supplied to the electrochemical device 20 along the non-transmission path sequentially passing through the first filter part 110→the third bypass line 230→the fifth bypass line 250→the third filter part 130 (the non-transmission path that does not pass through the second filter part).

According to the exemplary embodiment of the present disclosure, the filter apparatus 10 for an electrochemical device may include a first check valve 610 provided in the second bypass line 220 and configured to restrict a reverse flow of the target fluid, a second check valve 620 provided in the third bypass line 230 and configured to restrict a reverse flow of the target fluid, and a third check valve 630 provided in the fourth bypass line 240 and configured to restrict a reverse flow of the target fluid.

Various check valves capable of restricting the reverse flow of the target fluid moving along the second bypass line 220 may be used as the first check valve 610. The present disclosure is not restricted or limited by the type and structure of the first check valve 610.

Various check valves capable of restricting the reverse flow of the target fluid moving along the third bypass line 230 may be used as the second check valve 620. The present disclosure is not restricted or limited by the type and structure of the second check valve 620.

Various check valves capable of restricting the reverse flow of the target fluid moving along the fourth bypass line 240 may be used as the third check valve 630. The present disclosure is not restricted or limited by the type and structure of the third check valve 630.

While the embodiments have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

1. A filter apparatus for an electrochemical device, the filter apparatus comprising:
a supply line configured to supply a target fluid to an electrochemical device;
a first filter part positioned in the supply line;
a second filter part positioned at a downstream side of the first filter part and positioned in the supply line;
a first bypass line having a first end positioned at an upstream side of the first filter part and connected to the supply line, and a second end positioned between the first filter part and the second filter part and connected to the supply line;
a second bypass line having a first end positioned at a downstream side of the second filter part and connected to the supply line, and a second end positioned at the upstream side of the first filter part and connected to the supply line; and
a third bypass line having a first end positioned between the first filter part and the second filter part and connected to the supply line, and a second end positioned at the downstream side of the second filter part and connected to the supply line.

2. The filter apparatus of claim 1, comprising:
a first three-way valve positioned at the upstream side of the first filter part, provided in the supply line, and connected to the first end of the first bypass line;
a second three-way valve positioned between the first filter part and the second filter part, positioned in the supply line, and connected to the first end of the second bypass line; and
a third three-way valve positioned at the downstream side of the second filter part, positioned in the supply line, and connected to the first end of the second bypass line.

3. The filter apparatus of claim 2, comprising:
a third filter part positioned at the downstream side of the second filter part and positioned in the supply line.

4. The filter apparatus of claim 3, comprising:
a fourth bypass line having a first end connected to the first bypass line, and a second end positioned between the second filter part and the third filter part and connected to the supply line; and
a fifth bypass line having a first end positioned between the second filter part and the third filter part and connected to the supply line, and a second end connected to the third bypass line,
wherein the first end of the second bypass line is positioned at a downstream side of the third filter part and connected to the supply line.

5. The filter apparatus of claim 4, comprising:
a fourth three-way valve positioned between the second filter part and the second three-way valve, positioned in the supply line, and connected to the other end of the first bypass line;
a fifth three-way valve positioned between the second filter part and the third filter part, positioned in the supply line, and connected to the first end of the fifth bypass line; and
a sixth three-way valve positioned in the first bypass line and connected to the first end of the fourth bypass line.

6. The filter apparatus of claim 5, comprising:
a first ion sensor positioned at the upstream side of the first filter part, positioned in the supply line, and configured to sense ionic conductance of the target fluid;
a second ion sensor positioned between the first filter part and the second filter part, positioned in the supply line, and configured to sense ionic conductance of the target fluid;
a third ion sensor positioned between the second filter part and the third filter part, positioned in the supply line, and configured to sense ionic conductance of the target fluid; and
a fourth ion sensor positioned at the downstream side of the third filter part, positioned in the supply line, and configured to sense ionic conductance of the target fluid.

7. The filter apparatus of claim 6, wherein an order in which the target fluid passes through the first filter part, the second filter part, and the third filter part is determined based on sensing results of the first ion sensor, the second ion sensor, the third ion sensor, and the fourth ion sensor.

8. The filter apparatus of claim 7, wherein the target fluid is configured to move along any one of:
a first serial path sequentially passing through the first filter part, the second filter part, and the third filter part;
a second serial path sequentially passing through the second filter part, the third filter part, and the first filter part; and
a third serial path sequentially passing through the third filter part, the first filter part, and the second filter part.

9. The filter apparatus of claim 6, wherein the target fluid is configured to move along a non-transmission path, which does not pass through at least any one of the first filter part, the second filter part, and the third filter part, based on sensing results of the first ion sensor, the second ion sensor, the third ion sensor, and the fourth ion sensor.

10. The filter apparatus of claim 5, comprising:
a first flowmeter positioned at the upstream side of the first filter part, positioned in the supply line, and configured to measure a mass flow rate of the target fluid; and
a second flowmeter positioned at the downstream side of the third filter part, positioned in the supply line, and configured to measure a mass flow rate of the target fluid.

11. The filter apparatus of claim 10, wherein the target fluid is configured to move along a parallel path, which simultaneously passes through at least two or more of the first filter part, the second filter part, and the third filter part, based on sensing results of the first flowmeter and the second flowmeter.

12. The filter apparatus of claim 5, comprising:
a seventh three-way valve positioned in the third bypass line and connected to the second end of the fifth bypass line.

13. The filter apparatus of claim 5, wherein the second filter part comprises a filter module separable from the supply line.

14. The filter apparatus of claim 5, comprising:
a first check valve positioned in the second bypass line and configured to restrict a reverse flow of the target fluid;
a second check valve positioned in the third bypass line and configured to restrict a reverse flow of the target fluid; and
a third check valve positioned in the fourth bypass line and configured to restrict a reverse flow of the target fluid.
